(19) United States
(12) Patent Application Publication
(10) Pub. No.: US 2009/0313382 A1
(43) Pub. Date: Dec. 17, 2009

(54) METHOD AND APPARATUS FOR SIGNALING TIME-SHIFT SUPPORT

(75) Inventor: Imed Bouazizi, Tampere (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/468,197

(22) Filed: May 19, 2009

Related U.S. Application Data
(60) Provisional application No. 61/054,797, filed on May 20, 2008.

(51) Int. Cl. G06F 15/16

(52) U.S. Cl. 709/231; 709/234

(57) ABSTRACT

A method of supporting playback of streamed data comprises receiving a signal from a server indicative of support by the server of operations related to playback of streamed data; determining whether the server supports one or more operations for playback of the streamed data; and selectively enabling or disabling the one or more operations for a player on the user device.

### RELATED APPLICATIONS

This application was originally filed as U.S. Provisional Application No. 61/054,797 on May 20, 2009.

### FIELD OF INVENTION

This invention relates to multimedia streaming. In particular, the present invention relates to signaling of time-shift support.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Streaming services are becoming more and more popular with the significant advances in network access technologies, e.g., providing sufficient bandwidth, and media coding technologies, e.g., achieving improved quality. In streaming, the content is played out shortly after the reception from the remote server starts. The playback delay is typically in the range of couple of seconds, e.g., in client-server architecture, up to one or two minutes, e.g., for Peer-to-Peer streaming applications. This gives several advantages against download. On the one hand, the user experiences a much lower playback delay compared to full download. On the other hand, the receiver does not have to provide the necessary storage capacity for a full download.

Streaming services are deployed in several different applications: e.g. video on demand, IPTV, Mobile TV broadcast/multicast, peer-to-peer streaming. Different protocols for the setup and control of a streaming session are available, depending on the target application. The 3rd Generation Partnership Project (3GPP) defines a unicast streaming service, the Packet-switched Streaming Service (PSS), which enables live and stored content streaming over wireless unicast bearers to mobile users. The Digital Video Broadcast (DVB) defines an IPTV service that delivers live and stored content over fixed bearers (e.g. DSL lines) to the home of the user. The delivery may be performed in a unicast or multicast mode. Both applications make use of the Real-Time Streaming Protocol (RTSP) for the session setup and control of the streaming session.

RTSP is an HTTP-like textual protocol that runs typically over TCP/IP protocol stack. The RTSP protocol provides functionality for requesting a description of the streaming session using the DESCRIBE method. An example exchange in accordance with RTSP is illustrated in FIG. 1. The exchange between a client 202 and a server 204 begins with a DESCRIBE request 210 from the client 202 identifying the requested data to be streamed. The response 212 contains a session description, typically in Session Description Protocol (SDP) format. The session description may alternatively be acquired in other manners, such as from a web site, for example. A series of exchanges (214-226) result in the beginning of transmission of the data 228 for streaming.

### SUMMARY OF THE INVENTION

In one aspect of the invention, a method of supporting playback of streamed data comprises receiving a signal from a server indicative of support by the server of operations related to playback of streamed data; determining whether the server supports one or more operations for playback of the streamed data; and selectively enabling or disabling the one or more operations for a player on the user device.

In one embodiment, the one or more operations are selectively enabled or disabled for playback of segments of the streamed data. The one or more operations may be selectively disabled for playback of segments corresponding to advertisements.

In one embodiment, the determining whether a streaming server supports the one or more operations includes evaluation of already available information. In one embodiment, the determining whether a streaming server supports the one or more operations includes submitting a query to the streaming server. In one embodiment, the one or more operations include time-shifting operations.

In one embodiment, the one or more operations include trick-mode operations. The trick-mode operations may include scaled forward playback. The scaled forward playback may include scaling at 1.0, 2.0, 4.0, 8.0, −1.0, −2.0, −4.0, −8.0, 0.25, 0.5, −0.25 and −0.5.

In one embodiment, the one or more operations are selectively enabled or disabled based on position of current playback time with respect to live transmission. In one embodiment, the one or more operations are selectively enabled or disabled based on absolute times. In one embodiment, the one or more operations are selectively enabled or disabled based on relative times. In one embodiment, the one or more operations are selectively enabled or disabled based on specific events. In one embodiment, the method further comprises determining whether the user device supports the one or more operations for playback of the streamed data.

In another aspect of the invention, a method of supporting playback of data streamed from a server to a user device comprises forming a signal indicative of support by the server of operations related to playback of streamed data; and transmitting the signal by the server to the user device.

In another aspect of the invention, an apparatus comprises a receiver configured to receive a signal from a server indicative of support by the server of operations related to playback of streamed data; determine whether the server supports one or more operations for playback of the streamed data; and selectively enable or disable the one or more operations for a player on the user device.

In another aspect of the invention, an apparatus comprises a receiver configured to form a signal indicative of support by the server of operations related to playback of streamed data; and transmit the signal by the server to the user device.

In another aspect, the invention relates to an apparatus comprising a processor and a memory unit communicatively connected to the processor. The memory unit includes computer code for receiving a signal from a server indicative of support by the server of operations related to playback of streamed data; computer code for determining whether the server supports one or more operations for playback of the streamed data; and computer code for selectively enabling or disabling the one or more operations for a player on the user device.

In another aspect, the invention relates to an apparatus comprising a processor and a memory unit communicatively connected to the processor. The memory unit includes computer code for forming a signal indicative of support by the server of operations related to playback of streamed data; and computer code for transmitting the signal by the server to the user device.

In another aspect, a computer program product, embodied on a computer-readable medium, comprises a computer code for receiving a signal from a server indicative of support by the server of operations related to playback of streamed data; a computer code for determining whether the server supports one or more operations for playback of the streamed data; and a computer code for selectively enabling or disabling the one or more operations for a player on the user device.

In another aspect, a computer program product, embodied on a computer-readable medium, comprises a computer code for forming a signal indicative of support by the server of operations related to playback of streamed data; and a computer code for transmitting the signal by the server to the user device.

These and other advantages and features of various embodiments of the present invention, together with the organization and manner of operation thereof, will become apparent from the following detailed description when taken in conjunction with the accompanying drawings.

### BRIEF DESCRIPTION OF THE DRAWINGS

Embodiments of the invention are described by referring to the attached drawings, in which:

FIG. 1 illustrates an example exchange using RTSP;

FIG. 2 illustrates an example streaming and playback timeline;

FIG. 3 illustrates an example system for data streaming in accordance with an embodiment of the present invention;

FIG. 4 illustrates a block diagram of an example receiver in accordance with an embodiment of the present invention;

FIG. 5 illustrates a block diagram of an example server in accordance with an embodiment of the present invention;

FIG. 6 is a flow chart illustrating an example streaming process in accordance with an embodiment of the present invention;

FIG. 7 is an overview diagram of a system within which various embodiments of the present invention may be implemented;

FIG. 8 illustrates a perspective view of an example electronic device which may be utilized in accordance with the various embodiments of the present invention;

FIG. 9 is a schematic representation of the circuitry which may be included in the electronic device of FIG. 8; and

FIG. 10 is a graphical representation of a generic multimedia communication system within which various embodiments may be implemented.

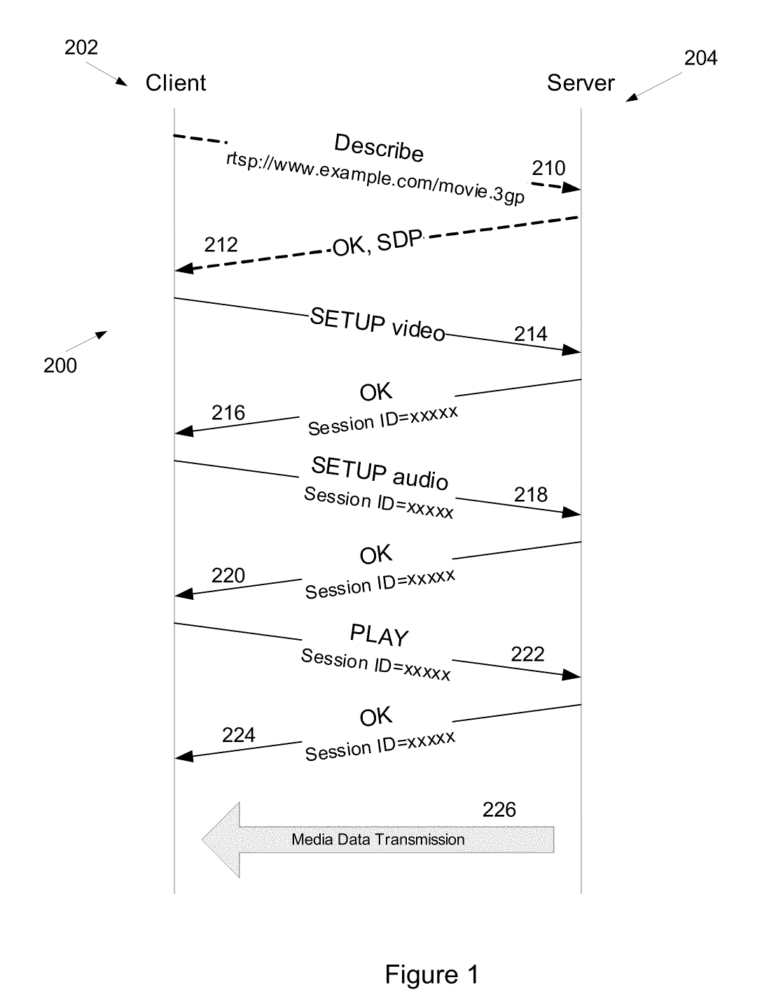

### DETAILED DESCRIPTION OF THE VARIOUS EMBODIMENTS

In the following description, for purposes of explanation and not limitation, details and descriptions are set forth in order to provide a thorough understanding of the present invention. However, it will be apparent to those skilled in the art that the present invention may be practiced in other embodiments that depart from these details and descriptions.

As noted above, the playback of streamed data may include a delay, or a time shift. The following scenarios for time shifting are possible:

1. Time shifting of a live stream that is originally delivered over unicast;

2. Time shifting of a live stream that is originally delivered over multicast/broadcast.

The receiver of the streamed data may desire to perform time shifting among a range supported by the server. The range may have a limited magnitude since the live content may not be stored indefinitely by the receiver. The receiver should be aware of the play range in order to assure correct playback behavior and user notification.

As an example, in a player of the receiver in time-shifted mode, the user may press a fast-forward button of the media player. The stream is then played at a faster rate. Upon reaching the time point of the live transmission, the fast forward playback mode stops and media data will be sent at the normal playback pace. If the player is not aware of that, inconsistency in the player behavior and by consequence confusion to the user may result.

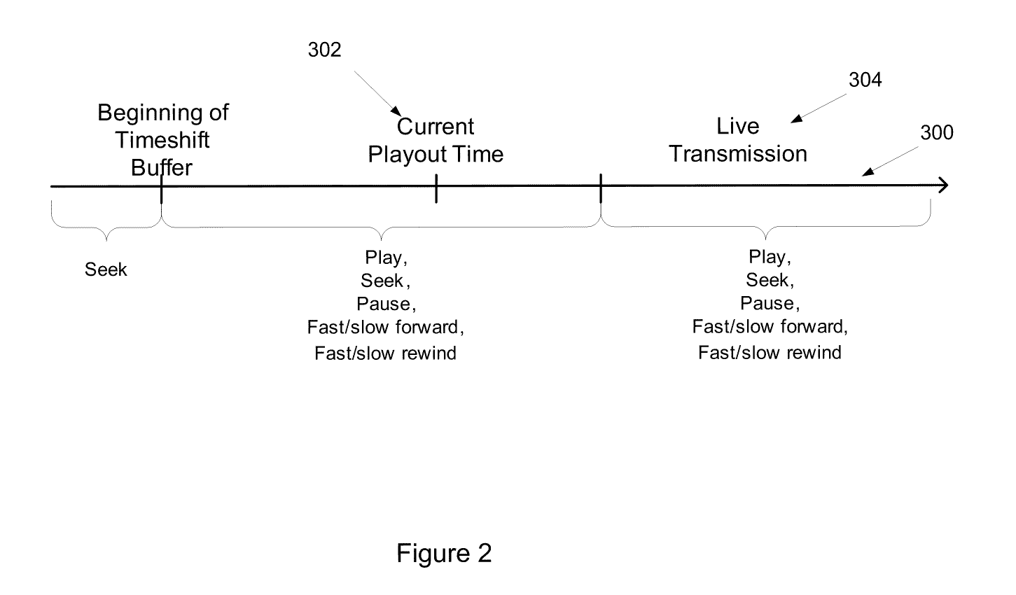

FIG. 2 illustrates an example playback timeline at the receiver and the corresponding allowed trick-mode operations. In this regard, “trick-mode” operations refer to scaled forward playback. For example, as illustrated in FIG. 2, trick modes may include seek, pause, fast or slow forward, or fast or slow rewind. In one embodiment, trick mode operations may include forward playback at scale factors of 1.0, 2.0, 4.0, 8.0, −1.0, −2.0, −4.0, −8.0, 0.25, 0.5, −0.25 and −0.5, for example. A scale factor of 1.0 refers to normal forward playback. The timeline 300 of FIG. 2 indicates the current playback time 302 as being earlier than the live transmission 304.

When reaching the live transmission interval, the player of the receiver should be aware so that it updates the player behavior (e.g., by disabling the Fast Forward button and restoring the original playback pace).

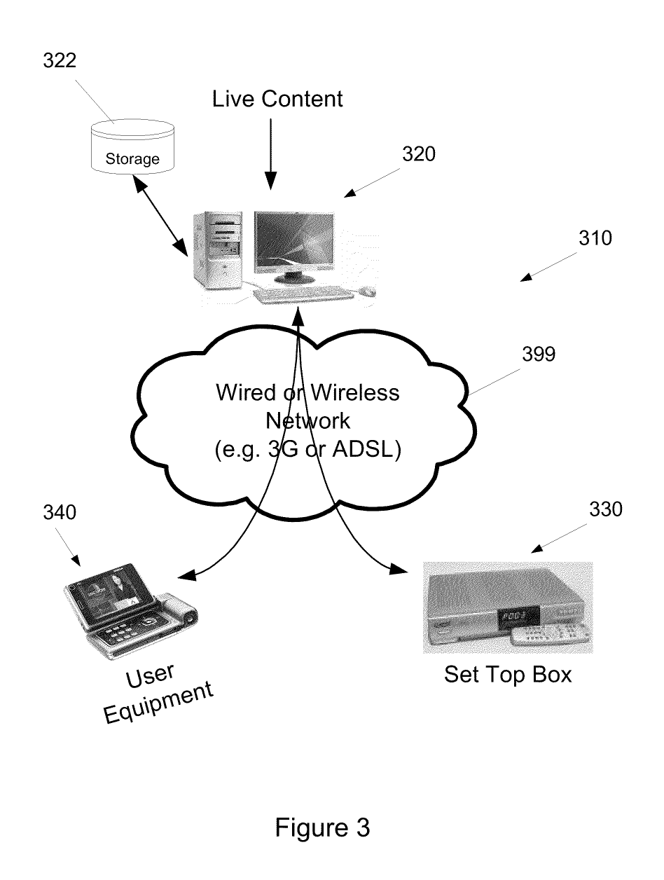

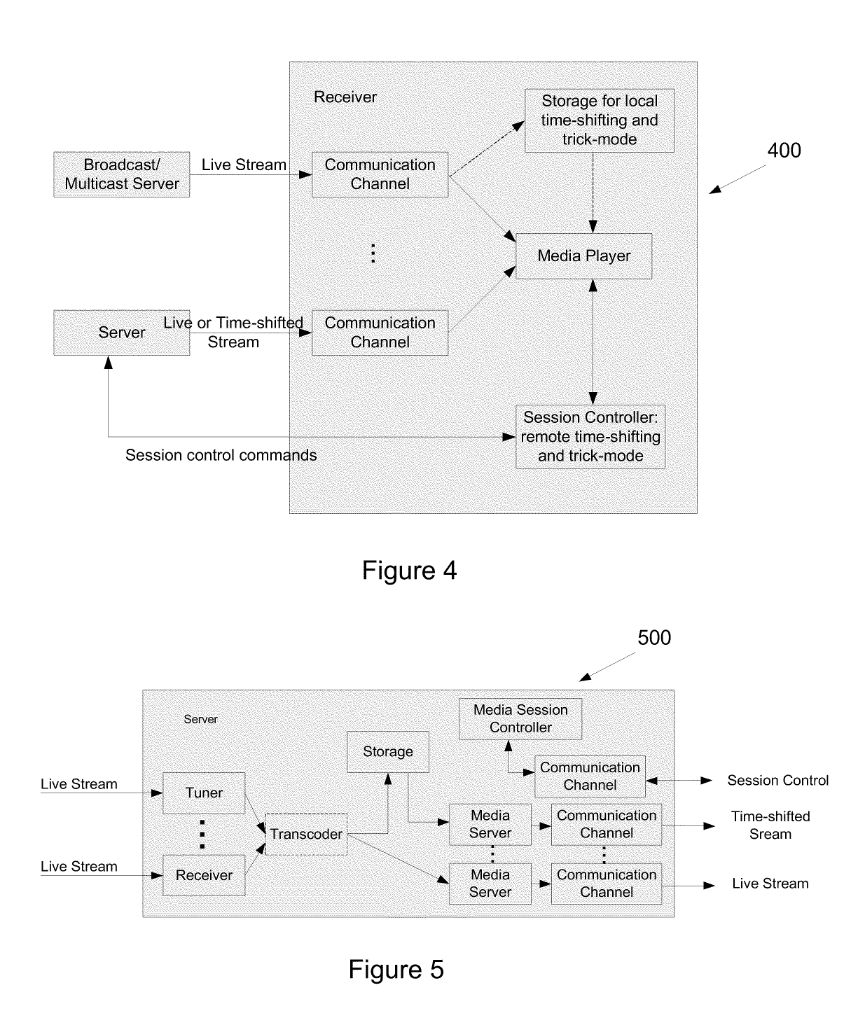

Embodiments of the present invention provide for remote time-shifting and trick-mode operations on live streams. Referring now to FIG. 3, an example system for streaming in accordance with an embodiment of the present invention is illustrated. The system 310 includes at least one receiver device, such as a set-top box 330 or a mobile user equipment 340, and one server device 320. A block diagram of an example receiver 400 is schematically illustrated in FIG. 4.

Referring again to FIG. 3, the server device 320 may be coupled to a storage device 322 such as a hard drive and/or a database, for example. In this regard, in accordance with embodiments of the invention, it is the server device 320 that is associated with storage of the data being streamed since a user device may have limited storage capability. A block diagram of an example server device 500 is illustrated in FIG. 5. The server may be any of a variety of servers. For example, the server may be a content-provider server or a streaming server, each referred to herein generically as a “server device” or a “streaming server”.

The server device 320 has access to one or more live streams. The server device 320 may perform processing operations on the live stream (e.g., transcoding) and may store portions of the live stream in the storage unit 322.

The receiver 330, 340 is configured to receive media streams over one of its communication channels, such as through a wired or wireless network 399. The receiver 330, 340 provides a user interface to the user to control the streaming session. The receiver 330, 340 may support one or several of the following control operations:
fast or slow forward;
fast or slow backward;
pause and subsequent resume;
seek; or
play with a starting point different from now.

In one embodiment, the receiver 330, 340 may receive and display a user guide to the user for improved session control. The receiver 330, 340 may include a local storage unit for local support for time-shifting and trick-mode operations. The receiver 330, 340 receives information about the location and possibly also capabilities of the server device 320 that supports remote time-shifting and trick-mode operations.

In accordance with embodiments of the present invention, the server device 320 informs the receiver 330, 340 about the portions of the live stream that are stored. This signaling may be done out-of-band (e.g., in a service guide) or in-band (e.g., over the control session between receiver and server). The signaling may be done prior to the session or during the session. The latter may be used to indicate changes in the support of time-shifting and trick-mode operations.

The receiver adjusts the playback behavior based on the information received from the server device. For example, the receiver may disable the “Fast Forward” operation when reaching the boundary of the time-shifting buffer where such operation may be inconsistent with proper playback.

In one embodiment, the server informs the receiver about the possible trick-mode operations that it supports for a specific stream and may also indicate on which components of the stream and with which parameters these operations are supported. In another embodiment, the receiver may query the server for support of time-shifting. This may be done during the setup of the session or during the lifetime of the session.

Based on a trigger at the receiver (e.g., user pressing a button), a time-shifting or trick-mode operation may be initiated. In this regard, the receiver may first check whether the local storage satisfies the requested operation. If not, the receiver initiates a connection to the server, if not already done.

Based on the information already received from the server either at the beginning of the session or during the session, the receiver is aware of the currently possible time-shifting and trick mode operations.

If the receiver detects that the requested operation is supported by the server, the receiver sends the command to the server. The receiver should disable operations that it knows are not supported by the server at a given time instant of the stream.

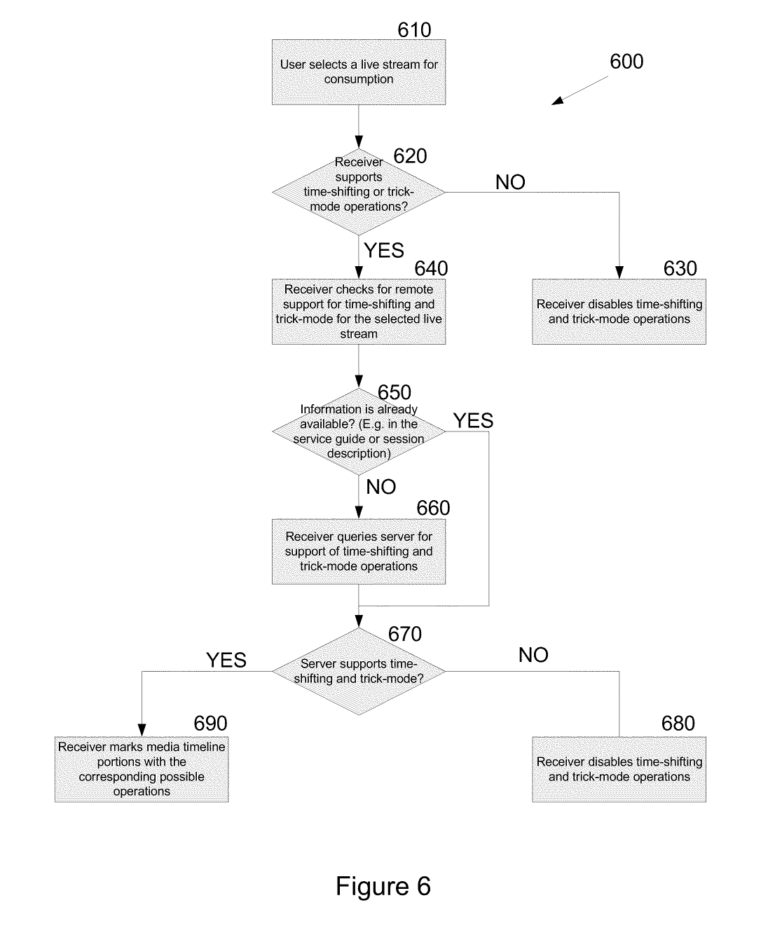

FIG. 6 is a flow chart illustrating an example process for streaming similar to that described above. In the example process 600, the user selects a live stream for consumption (block 610). As noted above, this may be accomplished through a DESCRIBE process. At block 620, the player at the receiver determines whether the receiver supports time-shifting or trick-mode operations. If the receiver does not support such operations, such operations are disabled (block 630) at the player, which may be an application on the receiver, for example. On the other hand, if the receiver supports time-shifting or trick-mode operations, the receiver or the player checks for remote support for time-shifting or trick-mode operations for the selected live stream (block 640). Checking for remote support includes whether the server provides such support. The checking for remote support may be achieved either through already available information (such as the service guide or session description, for example) (block 650) or through a query submitted to the server (block 660). At block 670, it is determined whether the already available information or the response to the query indicates that the server supports the time-shifting and trick-mode operations. If the server does not support such operations, the receiver disables such operations on the player (block 680). On the other hand, if the server does support such operations, the receiver marks the media timeline portions with appropriate corresponding available operations (block 690).

Thus, embodiments of the present invention may be applicable to various time-shifting and trick-mode scenarios, including:

1) Some programs of a live TV channel are recorded at the server for time-shifted play. Receiver is informed about those programs and marks the playback timeline accordingly (e.g., it enables the user to navigate in the past of a service guide and select a TV program that is indicated to be recorded). During playback of the selected portion, the user may do re-play, pause and resume, fast and slow forward and backward, and seek.

2) During a live event, the user presses a pause and then after some time presses resume/play. The user may select whether to resume from the paused time instant or from the actual live transmission time.

3) The user is consuming a live event and wants to replay a certain fragment of the live event. The receiver sends a seek to change the playback instant.

4) While consuming a live event, the user presses a fast/slow backward. While in time-shifted mode, the user presses a fast/slow forward.

5) The receiver is consuming a broadcast/multicast live session. The connection is interrupted because of a weak signal, for example. The receiver is aware of an alternative server and connects to it. For interruption free stream consumption, the receiver may start the session with the server in a time-shifted mode.

6) The user is in a different time-zone and cannot consume a broadcast/multicast event in time. The receiver is aware that the event is recorded by a server. The user consumes the event at a convenient time.

The server may support the following time-shifting modes:

1) records the previous x time units. The start of the time shifting buffer moves at the same pace as the current live transmission time;

2) records some portions of the live transmission Support for trick-mode may include:

1) playback at scales different than 1 are supported on all media streams or only on some of them. This may change depending on the playback scale.

The signaling options may include:

1) service announcement or service guide;

2) session control messages: RTSP messages;

3) session description e.g. SDP

In one embodiment, the streaming server serves a live session over the unicast bearer. The streaming client is informed about the time-shifting capability of the streaming server. A streaming server may or may not support time shifting and/or trick mode operations. In case it supports time-shifting, the streaming server also indicates the time-shifting depth, (i.e., the amount of old content (in time units) it will store to support time-shifting operations). In some cases, time shifting may only be supported for certain periods of the live content. The server then indicates a list of the time periods for which it supports time shifting. Thus, the time-shifting operations are enabled or disabled for playback of segments of the streamed data. The user can seek back to those time periods and playback the content. The server may also indicate whether trick mode operations and which scales are supported. Again, trick-mode operations are thus selectively enabled or disabled for playback of segments of the streamed data. For example, “fast forward” may be disabled for a segment associated with an advertisement.

In this regard, the signaling from the streaming server to the user equipment, or receiver, may identify periods during which time-shifting or trick-mode operations are either enabled or disabled. In one embodiment, the signaling includes indications of absolute times (e.g., measured from the beginning of the streamed data) at which such operations are enabled or disabled. In another embodiment, the signaling includes indications of relative times (e.g., measured from certain epochs, such as end of last segment) at which such operations are enabled or disabled. In still another embodiment, the signaling includes indications of specific events at which such operations are enabled or disabled.

Thus, in one embodiment, the streaming client starts the playback of the live stream from the current live transmission point. Alternatively, the streaming client triggers playback in time-shifting mode by starting the playback from a time point in the past. For the latter case, the streaming server informs the streaming client about the timeline and the timestamp that corresponds to the current live transmission time point, “now”, in the live transmission.

At a later time, the user may trigger time shifting mode by doing one of the following operations:
seek to a past time instant, e.g. for a replay;
pause and subsequent play (resume playback);
fast/slow backward

Once in time-shifted mode, the streaming server informs the streaming client about the boundaries of the time-shift timeline. This can be done as an indication of the current live time point with a relative or absolute starting time of the time shifting.

In accordance with embodiments of the present invention, the behavior of the streaming client for calculating the boundaries of the live stream (beginning of the time-shift buffer, live time point) is also communicated to the receiver.

Once in time shifted mode, the user may fast forward or seek to reach the live transmission point. The server then switches to normal playback, where fast forward is disabled.

The following is an explanation of an example embodiment of the invention and is not meant to be limiting. Various embodiments are considered and contemplated within the scope of the present invention.

Signaling the time-shifting capability of the server.

The streaming server may provide access to live content. In one embodiment, the streaming server may support time-shifting to a certain extent or for some specific portions/periods of the live stream. The streaming client must be aware of the playback operations the user is able to perform at a certain point of time, in order to ensure consistent player behavior.

Upon setting up a live streaming session, the streaming server may inform the streaming client about the time shifting options for the current content. In one embodiment, the information is transmitted using RTSP as it is the protocol for session control. The time-shifting information can be transmitted in the SET_PARAMETER, DESCRIBE, SETUP, and PLAY methods. Additionally, the time shifting information may be queried using the GET_PARAMETER method.

An RTSP parameter is defined with the name “timeshifting” and is used with SET_PARAMETER and GET_PARAMETER methods. A feature tag (“3gpp-timeshifting”) is defined to query for support of timeshifting and to ensure correct handling of the “timeshifting” parameter in the request. It may also be used with the Supported header to query for support of the time shifting functionality. The following is an example of an RTSP dialogue using the GET_PARAMETER.

C−>S: GET_PARAMETER
rtsp://www.nokia.com/presentation.3gp RTSP/1.0

CSeq: 3
Content-Type: text/parameters
Session: 12345678
Content-Length: 13

Require: 3gpp-timeshifting

User-Agent: 3GPP PSS Client/8.0
timeshifting
S−>C: RTSP/1.0 200 OK
CSeq: 3
Content-Length: 61

Require: 3gpp-timeshifting

Content-Type: text/parameters
timeshifting: 3417926400- 3417933600, 3417890400- 3417894000

In the above example, the time shifting capability is queried by the client. The “3gpp-timeshifting” feature in the Require header makes sure that the server will process the parameter and that a successful response indicates that the server understands the time-shifting parameter.

The response in the example above indicates in the body a list of time shifting periods for which time shifting is supported. An empty list would indicate that time-shifting is not supported for the current content. A single value would indicate the time shifting depth in seconds. Multiple indications are separated by a comma “,”.

A “Timeshifting” header field is also defined for used with the other RTSP methods (DESCRIBE, SETUP, and PLAY).

In the following, the ABNF syntax for the time-shifting indication is given. It applies both for the time-shifting parameter and time-shifting header field equally.

Timeshifting_header=”Timeshifting:” timeshifting_list CRLF
Timeshifting_parameter=”timeshifting: “ timeshifting_list CRLF
timeshifting_list=[interval / period_list]
period_list=period *(“,” period)
period=start_point “-“ end_point
start_point=1*DIGIT
end_point=1*DIGIT
interval=1*DIGIT

In the following, an example of the usage of the Timeshifting header field together with the DESCRIBE response is illustrated.

DESCRIBE rtsp://mediaserver.com/movie.test RTSP/1.0

CSeq: 1
Supported: 3gpp-timeshifting
User-Agent: 3GPP PSS Client/8.0

RTSP/1.0 200 OK

CSeq: 1
Supported: 3gpp-timeshifting
Timeshifting: 3600
Content-Type: application/sdp
Content-Length: 435
v=0
o=− 950814089 950814089 IN IP4 144.132.134.67
s=Example of aggregate control of AMR speech and H.263 video
e=foo@bar.com

c=IN IP4 0.0.0.0
b=AS:77
b=TIAS:69880

t=0 0
a=range:npt=0-59.3478
a=control:*

a=maxprate:20
m=audio 0 RTP/AVP 97
b=AS:13
b=TIAS:10680
b=RR:350
b=RS:300
a=maxprate:5

a=rtpmap:97 AMR/8000
a=fmtp:97
a=maxptime:200
a=control:streamID=0
m=video 0 RTP/AVP 98

b=AS:64
b=TIAS:59200
b=RR:2000
b=RS:1200
a=maxprate:15

a=rtpmap:98 H263-2000/90000
a=fmtp:98 profile=3;level=10
a=control: streamID=1

The response to the DESCRIBE request indicates that the server supports time-shifting for this content with a depth of 3600 seconds (1 hour). This enables the client to PAUSE and resume playback after an hour or to seek back one hour from the current live playback point.

Signalling Supported Trick Mode Operations

The streaming server may or may not support trick mode operations. Even when supporting trick mode operations, limitations on the playback pace supported might exist. The player should be aware of the scale values it is able to use for the current presentation. An indication of the type of scaled playback as well as which to which media streams it applies may also be indicated. When playing media at a different scale than 1.0, the server might not be able to support all media types with a scaled playback.

A mechanism for signaling the support of scaled playback is defined. The RTSP protocol defines a feature tag “play.scale” that must be used by the server to indicate support for scaled playback. The proposed additional signaling may be defined in form of a parameter that can be queried by the client using the GET_PARAMETER method or set by the server using the SET_PARAMETER method.

The ABNF syntax for the parameter may be defined as follows:

scales=“scales: ” stream-url “=” scale-spec *(“,” scale-spec) CRLF
scale-spec= stream-url “=” scale *(“;” scale)
scale=[“-”] 1*DIGIT [ “.” *DIGIT ]

The server may indicate the values for scale 1.0, which is supported for all media streams of a presentation.

Further, in a response to PLAY request with a scale other than 1.0, the server must include the indication of which media streams are streamed at the requested scale. This could be done as a separate RTSP header field that follows the same ABNF syntax as that of the parameter or alternatively, a modification to the syntax of the Scale header field is proposed as follows:

Scale=“Scale” HCOLON [“−”] 1*DIGIT[“.” *DIGIT] [“=” stream-url *(“,” stream-url)]CRLF

In case no additional indication of the media streams is given, the client assumes that the indicated scale is applied to all media streams of the presentation. If only a subset of the media streams of the presentation is indicated to be supported for the indicated scale, the client assumes that the other media streams will not be transmitted to the client as long as the playback is performed at that indicated scale.

Terminal Behavior in Time-Shifted Mode

When in time shifted mode, the client marks the time points that represent boundaries for the current playback operations on the playback timeline. This abstracts from the current playback scale. There are two types of boundaries:

Boundary to the live content: this boundary is not static but advances with the current live playback instance. The terminal gets an indication of the current live playback time instant in the play response. This may for example be realized using a new header field named “Live”. After that the client should keep track of the current live playback time instant and upon reaching that time instant it has to update the player behaviour accordingly. As an example, in case of a fast forward (playback with a scale >1.0), when reaching the live time point, the player shall indicate that to the receiver by changing the mode to normal playback. On the server side, upon reaching the live time point, the server shall switch to normal playback (at scale 1.0).

Boundary to non existent content. This boundary may either be variable or fixed. In case the current time shifting period is indicated to be an interval, the boundary for the start of the time shifting period is variable and advances at the same pace as the live transmission. In case the timeshifting support is indicated in form of a list of start and end periods, the boundary is fixed and corresponds to the start and end time of the current time period.

The player shall use the playback time (not its wallclock time) which is independent of the playback pace and direction (forward or backward)

Embodiments of the present invention may enable the streaming client and server to exchange information about the supported time-shifting and trick mode operation. This guarantees correct behavior at the player and a consistent user experience. The signaling is done in a backward compatible way to existing streaming protocols such as RTSP.

SDP Signaling Example

The indication of the time-shifting support and the time-shifting intervals may be done in the session description, e.g. in the SDP that describes the streaming session.

The following example shows the RTSP dialog to retrieve the SDP and shows an indication of the time-shifting support.

| | |
|---|---|
| C−>S: | DESCRIBE |

rtsp://mediaserver.com/movie.test RTSP/1.0

CSeq: 1
Supported: 3gpp-timeshifting
User-Agent: TheStreamClient/1.1b2

| | |
|---|---|
| S−>C: | RTSP/1.0 200 OK |

CSeq: 1
Content-Type: application/sdp
Supported: 3gpp-timeshifting
Content-Length: 435
v=0
o=− 950814089 950814089 IN IP4 144.132.134.67
s=Example of aggregate control of AMR speech and H.263 video
e=foo@bar.com
c=IN IP4 0.0.0.0
b=AS:77
b=TIAS:69880
t=0 0
a=range:npt=0-59.3478
a=control:*
a=maxprate:20
a=X-timeshifting: 7200
m=audio 0 RTP/AVP 97
b=AS:13
b=TIAS:10680
b=RR:350
b=RS:300
a=maxprate:5
a=rtpmap:97 AMR/8000
a=fmtp:97
a=maxptime:200
a=control:streamID=0
a=X-scale: 1.0
m=video 0 RTP/AVP 98
b=AS:64
b=TIAS:59200
b=RR:2000
b=RS:1200
a=maxprate:15
a=rtpmap:98 H263-2000/90000
a=fmtp:98 profile=3;level=10
a=control: streamID=1
a=X-scale: 1.0, 2.0, 4.0, 8.0, −1.0, −2.0, −4.0, −8.0

ESG Signaling Example

The service guide may contain an indication that a specific event is recorded and will be made available for time-shift operations at a later point. The indication may also include the date at which the recording will be deleted from the server. The following example shows how this may be realized using the OMA BCAST service guide data model:

| Name | Category | Cardinality | Description | Data Type |
|---|---|---|---|---|
| Schedule | | | ‘Schedule’ fragment | |
| | | | Contains the | |
| | | | following attributes: | |
| | | | id | |
| | | | version | |
| | | | defaultSchedule | |
| | | | onDemand | |
| | | | validFrom | |
| | | | validTo | |
| | | | Contains the | |
| | | | following elements: | |
| | | | ServiceReference | |
| | | | InteractivityDataReference | |
| | | | ContentReference | |
| | | | PreviewDataReference | |
| | | | TermsOfUse | |
| | | | PrivateExt | |
| | | | Timeshifting | |
| Time- | NO/TO | 0 . . . 1 | Contains | |
| shifting | | | information about | |
| | | | the time shifting | |
| | | | support for the | |
| | | | current event. | |
| | | | Contains the | |
| | | | following attributes: | |
| | | | Mode | |
| | | | Contains the | |
| | | | following elements: | |
| | | | Expiry | |
| Mode | M | | Indicates the mode | |
| | | | of the time shifting | |
| | | | support, which can | |
| | | | take the following | |
| | | | values: | |
| | | | None | |
| | | | Event-based | |
| | | | 3) Depth-based | |
| Expiry | | 0 . . . 1 | indicates the expiry | unsigned |
| | | | time for the recoding | int |
| | | | of this event. After | |
| | | | this time, receivers | |
| | | | may not time shift | |
| | | | back to this event. | |

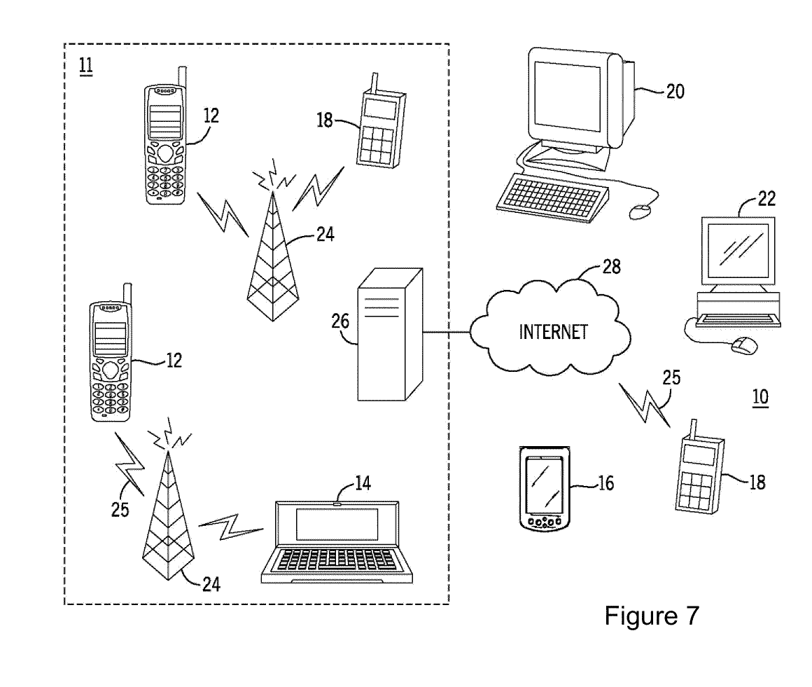

FIG. 7 shows a system 10 in which various embodiments of the present invention can be utilized, comprising multiple communication devices that can communicate through one or more networks. The system 10 may comprise any combination of wired or wireless networks including, but not limited to, a mobile telephone network, a wireless Local Area Network (LAN), a Bluetooth personal area network, an Ethernet LAN, a token ring LAN, a wide area network, the Internet, etc. The system 10 may include both wired and wireless communication devices.

For exemplification, the system 10 shown in FIG. 7 includes a mobile telephone network 11 and the Internet 28. Connectivity to the Internet 28 may include, but is not limited to, long range wireless connections, short range wireless connections, and various wired connections including, but not limited to, telephone lines, cable lines, power lines, and the like.

The example communication devices of the system 10 may include, but are not limited to, an electronic device 12 in the form of a mobile telephone, a combination personal digital assistant (PDA) and mobile telephone 14, a PDA 16, an integrated messaging device (IMD) 18, a desktop computer 20, a notebook computer 22, etc. The communication devices may be stationary or mobile as when carried by an individual who is moving. The communication devices may also be located in a mode of transportation including, but not limited to, an automobile, a truck, a taxi, a bus, a train, a boat, an airplane, a bicycle, a motorcycle, etc. Some or all of the communication devices may send and receive calls and messages and communicate with service providers through a wireless connection 25 to a base station 24. The base station 24 may be connected to a network server 26 that allows communication between the mobile telephone network 11 and the Internet 28. The system 10 may include additional communication devices and communication devices of different types.

The communication devices may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device involved in implementing various embodiments of the present invention may communicate using various media including, but not limited to, radio, infrared, laser, cable connection, and the like.

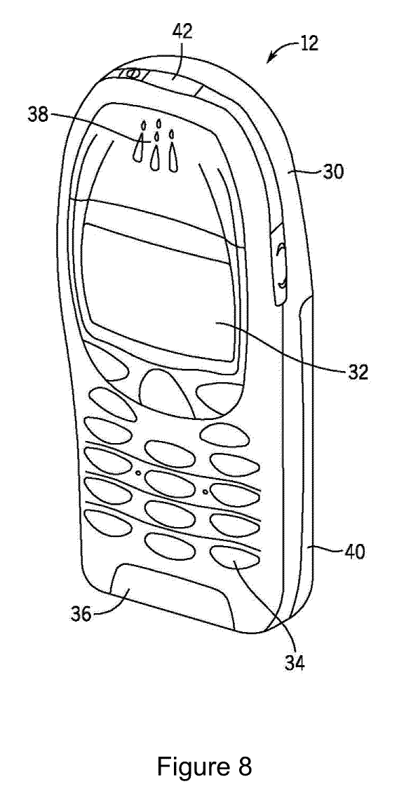

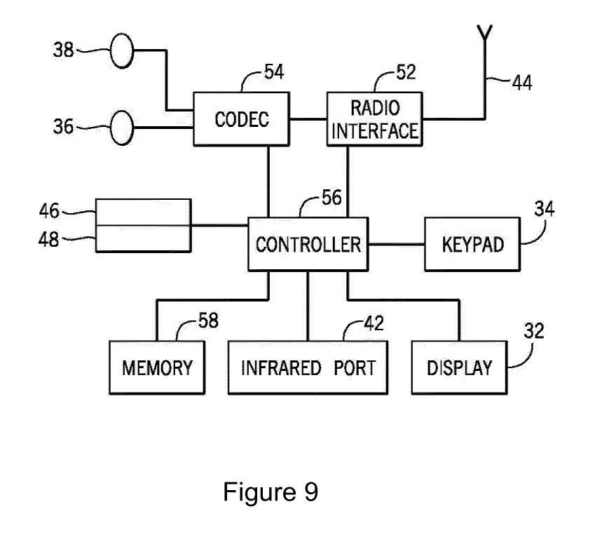

FIGS. 8 and 9 show one representative electronic device 28 which may be used as a network node in accordance to the various embodiments of the present invention. It should be understood, however, that the scope of the present invention is not intended to be limited to one particular type of device. The electronic device 28 of FIGS. 8 and 9 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment, a card reader 48, radio interface circuitry 52, codec circuitry 54, a controller 56 and a memory 58. The above described components enable the electronic device 28 to send/receive various messages to/from other devices that may reside on a network in accordance with the various embodiments of the present invention. Individual circuits and elements are all of a type well known in the art, for example in the Nokia range of mobile telephones.

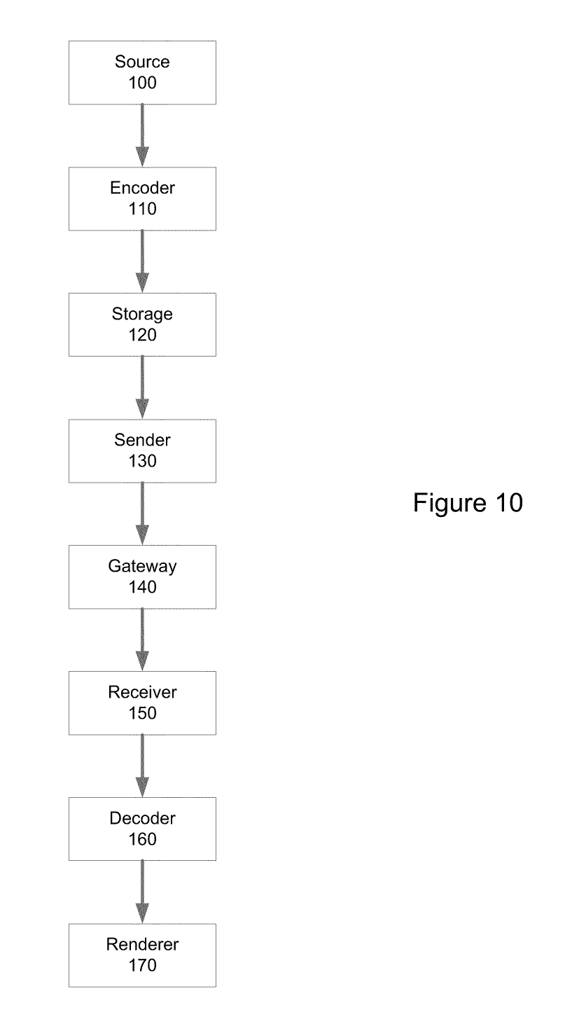

FIG. 10 is a graphical representation of a generic multimedia communication system within which various embodiments may be implemented. As shown in FIG. 10, a data source 100 provides a source signal in an analog, uncompressed digital, or compressed digital format, or any combination of these formats. An encoder 110 encodes the source signal into a coded media bitstream. It should be noted that a bitstream to be decoded can be received directly or indirectly from a remote device located within virtually any type of network. Additionally, the bitstream can be received from local hardware or software. The encoder 110 may be capable of encoding more than one media type, such as audio and video, or more than one encoder 110 may be required to code different media types of the source signal. The encoder 110 may also get synthetically produced input, such as graphics and text, or it may be capable of producing coded bitstreams of synthetic media. In the following, only processing of one coded media bitstream of one media type is considered to simplify the description. It should be noted, however, that typically real-time broadcast services comprise several streams (typically at least one audio, video and text sub-titling stream). It should also be noted that the system may include many encoders, but in FIG. 10 only one encoder 110 is represented to simplify the description without a lack of generality. It should be further understood that, although text and examples contained herein may specifically describe an encoding process, one skilled in the art would understand that the same concepts and principles also apply to the corresponding decoding process and vice versa.

The coded media bitstream is transferred to a storage 120. The storage 120 may comprise any type of mass memory to store the coded media bitstream. The format of the coded media bitstream in the storage 120 may be an elementary self-contained bitstream format, or one or more coded media bitstreams may be encapsulated into a container file. Some systems operate “live”, i.e. omit storage and transfer coded media bitstream from the encoder 110 directly to the sender 130. The coded media bitstream is then transferred to the sender 130, also referred to as the server, on a need basis. The format used in the transmission may be an elementary self-contained bitstream format, a packet stream format, or one or more coded media bitstreams may be encapsulated into a container file. The encoder 110, the storage 120, and the server 130 may reside in the same physical device or they may be included in separate devices. The encoder 110 and server 130 may operate with live real-time content, in which case the coded media bitstream is typically not stored permanently, but rather buffered for small periods of time in the content encoder 110 and/or in the server 130 to smooth out variations in processing delay, transfer delay, and coded media bitrate.

The server 130 sends the coded media bitstream using a communication protocol stack. The stack may include but is not limited to Real-Time Transport Protocol (RTP), User Datagram Protocol (UDP), and Internet Protocol (IP). When the communication protocol stack is packet-oriented, the server 130 encapsulates the coded media bitstream into packets. For example, when RTP is used, the server 130 encapsulates the coded media bitstream into RTP packets according to an RTP payload format. Typically, each media type has a dedicated RTP payload format. It should be again noted that a system may contain more than one server 130, but for the sake of simplicity, the following description only considers one server 130.

The server 130 may or may not be connected to a gateway 140 through a communication network. The gateway 140 may perform different types of functions, such as translation of a packet stream according to one communication protocol stack to another communication protocol stack, merging and forking of data streams, and manipulation of data stream according to the downlink and/or receiver capabilities, such as controlling the bit rate of the forwarded stream according to prevailing downlink network conditions. Examples of gateways 140 include MCUs, gateways between circuit-switched and packet-switched video telephony, Push-to-talk over Cellular (PoC) servers, IP encapsulators in digital video broadcasting-handheld (DVB-H) systems, or set-top boxes that forward broadcast transmissions locally to home wireless networks. When RTP is used, the gateway 140 is called an RTP mixer or an RTP translator and typically acts as an endpoint of an RTP connection.

The system includes one or more receivers 150, typically capable of receiving, de-modulating, and de-capsulating the transmitted signal into a coded media bitstream. The coded media bitstream is transferred to a recording storage 155. The recording storage 155 may comprise any type of mass memory to store the coded media bitstream. The recording storage 155 may alternatively or additively comprise computation memory, such as random access memory. The format of the coded media bitstream in the recording storage 155 may be an elementary self-contained bitstream format, or one or more coded media bitstreams may be encapsulated into a container file. If there are multiple coded media bitstreams, such as an audio stream and a video stream, associated with each other, a container file is typically used and the receiver 150 comprises or is attached to a container file generator producing a container file from input streams. Some systems operate “live,” i.e. omit the recording storage 155 and transfer coded media bitstream from the receiver 150 directly to the decoder 160. In some systems, only the most recent part of the recorded stream, e.g., the most recent 10-minute excerption of the recorded stream, is maintained in the recording storage 155, while any earlier recorded data is discarded from the recording storage 155.

The coded media bitstream is transferred from the recording storage 155 to the decoder 160. If there are many coded media bitstreams, such as an audio stream and a video stream, associated with each other and encapsulated into a container file, a file parser (not shown in the figure) is used to decapsulate each coded media bitstream from the container file. The recording storage 155 or a decoder 160 may comprise the file parser, or the file parser is attached to either recording storage 155 or the decoder 160.

The coded media bitstream is typically processed further by a decoder 160, whose output is one or more uncompressed media streams. Finally, a renderer 170 may reproduce the uncompressed media streams with a loudspeaker or a display, for example. The receiver 150, recording storage 155, decoder 160, and renderer 170 may reside in the same physical device or they may be included in separate devices.

A sender 130 according to various embodiments may be configured to select the transmitted layers for multiple reasons, such as to respond to requests of the receiver 150 or prevailing conditions of the network over which the bitstream is conveyed. A request from the receiver can be, e.g., a request for a change of layers for display or a change of a rendering device having different capabilities compared to the previous one.

Various embodiments described herein are described in the general context of method steps or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

Embodiments of the present invention may be implemented in software, hardware, application logic or a combination of software, hardware and application logic. The software, application logic and/or hardware may reside, for example, on a chipset, a mobile device, a desktop, a laptop or a server. Software and web implementations of various embodiments can be accomplished with standard programming techniques with rule-based logic and other logic to accomplish various database searching steps or processes, correlation steps or processes, comparison steps or processes and decision steps or processes. Various embodiments may also be fully or partially implemented within network elements or modules. It should be noted that the words “component” and “module,” as used herein and in the following claims, is intended to encompass implementations using one or more lines of software code, and/or hardware implementations, and/or equipment for receiving manual inputs.

The foregoing description of embodiments has been presented for purposes of illustration and description. The foregoing description is not intended to be exhaustive or to limit embodiments of the present invention to the precise form disclosed, and modifications and variations are possible in light of the above teachings or may be acquired from practice of various embodiments. The embodiments discussed herein were chosen and described in order to explain the principles and the nature of various embodiments and its practical application to enable one skilled in the art to utilize the present invention in various embodiments and with various modifications as are suited to the particular use contemplated. The features of the embodiments described herein may be combined in all possible combinations of methods, apparatus, modules, systems, and computer program products.

In one aspect of the invention, a method of supporting playback of streamed data comprises receiving a signal from a server indicative of support by the server of operations related to playback of streamed data; determining whether the server supports one or more operations for playback of the streamed data; and selectively enabling or disabling the one or more operations for a player on the user device.

In one embodiment, the one or more operations are selectively enabled or disabled for playback of segments of the streamed data. The one or more operations may be selectively disabled for playback of segments corresponding to advertisements.

In one embodiment, the determining whether a streaming server supports the one or more operations includes evaluation of already available information. In one embodiment, the determining whether a streaming server supports the one or more operations includes submitting a query to the streaming server. In one embodiment, the one or more operations include time-shifting operations.

In one embodiment, the one or more operations include trick-mode operations. The trick-mode operations may include scaled forward playback. The scaled forward playback may include scaling at 1.0, 2.0, 4.0, 8.0, −1.0, −2.0, −4.0, −8.0, 0.25, 0.5, −0.25 and −0.5.

In one embodiment, the one or more operations are selectively enabled or disabled based on position of current playback time with respect to live transmission. In one embodiment, the one or more operations are selectively enabled or disabled based on absolute times. In one embodiment, the one or more operations are selectively enabled or disabled based on relative times. In one embodiment, the one or more operations are selectively enabled or disabled based on specific events. In one embodiment, the method further comprises determining whether the user device supports the one or more operations for playback of the streamed data.

In another aspect of the invention, a method of supporting playback of data streamed from a server to a user device comprises forming a signal indicative of support by the server of operations related to playback of streamed data; and transmitting the signal by the server to the user device.

In another aspect of the invention, an apparatus comprises a receiver configured to receive a signal from a server indicative of support by the server of operations related to playback of streamed data; determine whether the server supports one or more operations for playback of the streamed data; and selectively enable or disable the one or more operations for a player on the user device.

In another aspect of the invention, an apparatus comprises a receiver configured to form a signal indicative of support by the server of operations related to playback of streamed data; and transmit the signal by the server to the user device.

In another aspect, the invention relates to an apparatus comprising a processor and a memory unit communicatively connected to the processor. The memory unit includes computer code for receiving a signal from a server indicative of support by the server of operations related to playback of streamed data; computer code for determining whether the server supports one or more operations for playback of the streamed data; and computer code for selectively enabling or disabling the one or more operations for a player on the user device.

In another aspect, the invention relates to an apparatus comprising a processor and a memory unit communicatively connected to the processor. The memory unit includes computer code for forming a signal indicative of support by the server of operations related to playback of streamed data; and computer code for transmitting the signal by the server to the user device.

In another aspect, a computer program product, embodied on a computer-readable medium, comprises a computer code for receiving a signal from a server indicative of support by the server of operations related to playback of streamed data; a computer code for determining whether the server supports one or more operations for playback of the streamed data; and a computer code for selectively enabling or disabling the one or more operations for a player on the user device.

In another aspect, a computer program product, embodied on a computer-readable medium, comprises a computer code for forming a signal indicative of support by the server of operations related to playback of streamed data; and a computer code for transmitting the signal by the server to the user device.

What is claimed is:

1. A method comprising:
receiving information related to remote support by a server of time-shift and trick mode operations in a real-time media streaming session;
determining whether the server supports one or more time-shift and trick mode operations based at least in part on the received information; and
selectively enabling or disabling the one or more operations for a player on a user device.

2. A method according to claim 1, further comprises querying the server about remote support of time-shift and trick mode operations.

3. A method according to claim 1, further comprises receiving information related to boundaries of at least one interval during which time-shifting and trick mode operations are supported, said boundaries being either absolute or relative to an actual live transmission point.

4. A method according to claim 3, wherein the one or more operations are selectively enabled or disabled based at least in part on current playback time position with respect to the boundaries of said at least one interval.

5. A method according to claim 1, wherein said time shift and trick mode operations comprise at least one of scaled forward playback, scaled rewind, pause and subsequent resume of playback, playback at a time position different from an actual live transmission point and seeking a change of a playback instance.

6. A method according to claim 5, further comprises receiving information related to supported scaling values associated with at least one of scaled forward playback and scaled rewind.

7. A method according to claim 1, wherein said information related to remote support of time-shift and trick mode operations is received in at least one of a service announcement, a service guide, a session control message and a session description protocol message.

8. An apparatus comprises:
a receiver configured to receive information related to remote support by a server of time-shift and trick mode operations in a real-time media streaming session; and
a processor configured to
determine whether the server supports one or more time-shift and trick mode operations based at least in part on the received information, and
selectively enable or disable the one or more operations for a player on a user device.

9. An apparatus according to claim 8, wherein the processor is further configured to query the server about remote support of time-shift and trick mode operations.

10. An apparatus according to claim 8, wherein the receiver is further configured to receive information related to boundaries of at least one interval during which time-shifting and trick mode operations are supported, said boundaries being either absolute or relative to an actual live transmission point.

11. An apparatus according to claim 10, wherein the one or more operations are selectively enabled or disabled based at least in part on current playback time position with respect to the boundaries of said at least one interval.

12. An apparatus according to claim 8, wherein said time shift and trick mode operations comprise at least one of scaled forward playback, scaled rewind, pause and subsequent resume of playback, playback at a time position different from an actual live transmission point and seeking a change of a playback instance.

13. An apparatus according to claim 12, wherein the receiver is further configured to receive information related to supported scaling values associated with at least one of scaled forward playback and scaled rewind.

14. An apparatus according to claim 8, wherein said information related to remote support of time-shift and trick mode operations is received in at least one of a service announcement, a service guide, a session control message and a session description protocol message.

15. A method comprising:
buffering, by a server, at least one portion of a real-time streamed media content;
forming a signal indicative of remote support by the server of time-shift and trick mode operations related to playback of real-time streamed media content; and
transmitting the signal by the server to a user device.

16. An apparatus comprising:
A memory unit configured to buffer at least one portion of a real-time streamed media content; and
A processor configured to:
form a signal indicative of remote support by the apparatus of time-shift and trick mode operations related to playback of said real-time streamed media content; and
transmit the signal to a user device.

17. An apparatus according to claim 16, wherein the processor is further configured to send information, to said user device, related to boundaries of said at least one buffered portion and wherein said time-shift and trick mode operations are supported only within said boundaries.

18. An apparatus according to claim 16, wherein said time shift and trick mode operations comprise at least one of scaled forward playback, scaled rewind, pause and subsequent resume of playback, playback at a time position different from an actual live transmission point and seeking a change of a playback instance.

19. An apparatus according to claim 18, wherein the processor is further configured to send information related to supported scaling values associated with at least one of scaled forward playback and scaled rewind.

20. An apparatus according to claim 16, wherein said signal comprise at least one of a service announcement, a service guide, a session control message and a session description protocol message.

21. A computer program product, embodied on a computer-readable medium, comprises a computer code configured to perform the process of claim 1.

22. A computer program product, embodied on a computer-readable medium, comprises a computer code configured to perform the process of claim 15.
